(19) United States
(12) Patent Application Publication
(10) Pub. No.: US 2017/0282503 A1
(43) Pub. Date: Oct. 5, 2017

(54) LAMINATED GLASS ARTICLE WITH ION EXCHANGEABLE CORE AND CLADS LAYERS HAVING DIFFUSIVITY CONTRAST AND METHODS OF MAKING THE SAME

(71) Applicant: CORNING INCORPORATED, CORNING, NY (US)

(72) Inventors: Gaozhu Peng, Horseheads, NY (US); Chunfeng Zhou, Painted post, NY (US)

(21) Appl. No.: 15/507,005

(22) PCT Filed: Aug. 25, 2015
(86) PCT No.: PCT/US15/46685

§ 371 Date: Feb. 27, 2017

Related U.S. Application Data
(60) Provisional application No. 62/043,011, filed on Aug. 28, 2014.

(51) Int. Cl. B32B 17/06; C03C 21/00

(52) U.S. Cl. CPC B32B 17/06; C03C 21/002; B32B 2457/20

(57) ABSTRACT

A laminated glass article has a first layer having a first ion exchange diffusivity, D₀, and a second layer adjacent to the first layer and having a second ion exchange diffusivity, D₁. D₀/D₁ is from about 1.2 to about 10, or D₀/D₁ is from about 0.05 to about 0.95. A method for manufacturing the laminated glass article includes forming a first layer having a first ion exchange diffusivity, D₀, and forming a second layer adjacent to the first layer and having a second ion exchange diffusivity, D₁. The laminated glass article can be strengthened by an ion exchange process to form a strengthened laminated glass article having a compressive stress layer with a depth of layer from about 8 μm to about 100 μm.

This application claims the benefit of priority to U.S. Provisional Application 62/043,011 filed Aug. 28, 2014 content of which is incorporated herein by reference in its entirety.

### BACKGROUND

### Field

The present specification generally relates to laminated glass articles and, more specifically, to laminated glass articles having an ion exchange diffusivity contrast between adjacent layers.

### Technical Background

Portable electronic devices, such as smart phones, are a growing industry. Despite using chemically strengthened glass as cover glass for portable devices, breakage of cover glass continues to be a problem encountered in the industry. However, increasing the damage resistance of the strengthened glass by merely increasing a depth and/or the compressive stress of the compressive stress layer may lead to strengthened cover glasses that do not meet frangibility requirements for known applications.

Accordingly, there remains a need for strengthened glass with increased damage resistance that resists breakage while meeting the frangibility requirements of the industry.

### SUMMARY

According to one embodiment, a laminated glass article is disclosed comprising a first layer comprising a first ion exchange diffusivity, D₀, and a second layer adjacent to the first layer and comprising a second ion exchange diffusivity, D₁. D₀/D₁ is from about 1.2 to about 10.

According to another embodiment, a laminated glass article is disclosed comprising a first layer comprising a first ion exchange diffusivity, D₀, and a second layer adjacent to the first layer and comprising a second ion exchange diffusivity, D₁. D₀/D₁ is from about 0.05 to about 0.95.

According to another embodiment, a method for manufacturing a laminated glass article is disclosed, the method comprising forming a first layer having a first ion exchange diffusivity, D₀, and forming a second layer adjacent to the first layer and having a second ion exchange diffusivity, D₁. D₀/D₁ is either from about 1.5 to about 10 or D₀/D₁ is from about 0.05 to about 0.95. The laminated glass article can be strengthened by an ion exchange process to form a strengthened laminated glass article having a compressive stress layer with a depth of layer from about 8 μm to about 100 μm.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1A schematically depicts a laminated glass article having 2n+1 layers according to embodiments disclosed and described herein;

FIG. 1B schematically depicts a laminated glass article having three layers according to embodiments disclosed and described herein;

FIG. 2 schematically depicts an apparatus for forming a laminated glass article according to embodiments disclosed and described herein;

FIG. 3 schematically depicts an apparatus for forming a laminated glass article having three layers according to embodiments disclosed and described herein;

FIG. 4 schematically depicts an apparatus for forming a laminated glass article having seven layers according to embodiments disclosed and described herein;

FIG. 5 is a graph depicting threshold central tensions according to embodiments disclosed and described herein;

FIG. 6 is a graph depicting stress profiles of three-layer laminated glass article where the core layer has higher ion exchange diffusivity than the clad layers according to embodiments disclosed and described herein;

FIG. 7 is a graph depicting stress profiles of three-layer laminated glass article where the core layer has higher ion exchange diffusivity than the clad layers according to embodiments disclosed and described herein;

FIG. 8 is a graph depicting stress profiles of three-layer laminated glass article where the core layer has lower ion exchange diffusivity than the clad layers according to embodiments disclosed and described herein;

FIG. 9 is a graph depicting stress profiles of three-layer laminated glass article where the core layer has lower ion exchange diffusivity than the clad layers according to embodiments disclosed and described herein;

FIG. 10 is a graph depicting stress profiles of three-layer laminated glass article having differing depth of layer according to embodiments disclosed and described herein;

FIG. 11 is a graph depicting stress profiles of laminated glass article having five layers according to embodiments disclosed and described herein; and

FIG. 12 is a graph depicting stress profiles of a laminated glass article that undergoes two-step ion exchange processes.

### DETAILED DESCRIPTION

Surface compressive stress and depth of the compressive stress layer (hereinafter referred to as depth of layer or DOL) are commonly used to characterize chemically strengthened glass. When calculating the stress profile, as measured by compressive stress over the DOL, it has previously been thought that the shape of the stress profile is either linear or follows a complimentary error function. However, controlling the stress profile over the entire depth of the compressive stress layer allows engineered cover glass that has adequate strength and desirable frangibility characteristics.

Previously, to increase damage resistance of strengthened glass, two-step ion exchange processes were conducted, but two-step ion exchange processes generally involve complex combinations of ion-exchange bath concentration and temperature to avoid unwanted surface tension. Therefore, two-step ion exchange generally is difficult to perfect and quite costly. Additionally, heat treatments below the strain point of the glass have been used in an attempt to improve the damage resistance of strengthened glass, but this additional heat treatment increases the cost and complexity of forming the glass.

Embodiments disclosed herein address the above issues by forming laminate glass articles having contrasting ion exchange diffusivities between the core layer and the clad layer(s).

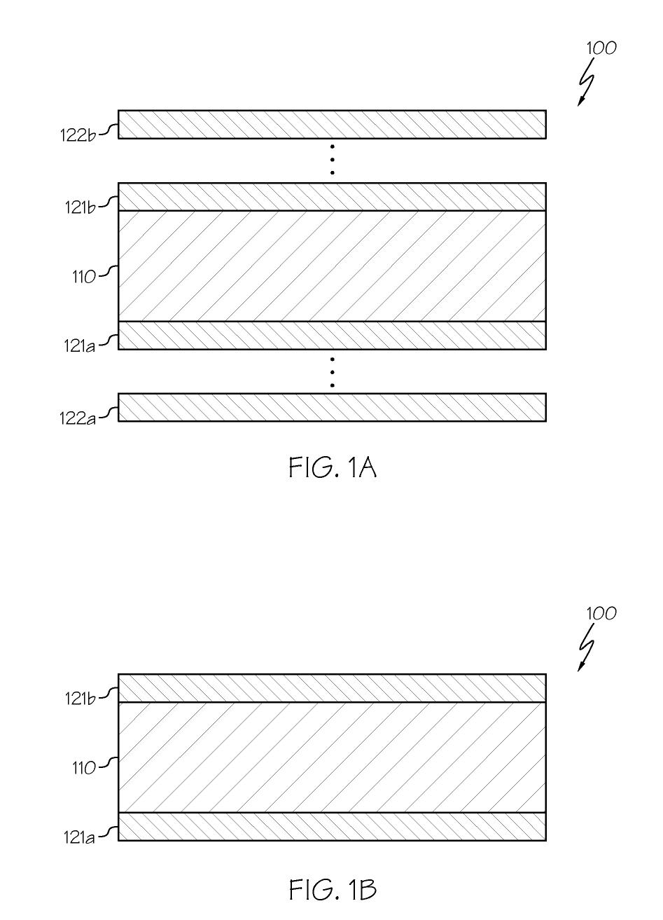

Laminated glass articles generally comprise two or more layers of glass which are fused together to form a single, unitary body. In some embodiments, a laminated glass article comprises a glass sheet. The glass sheet can be substantially planar (e.g., flat) or non-planar (e.g., curved). In other embodiments, a laminated glass article comprises a formed or shaped glass article comprising a three-dimensional (3D) shape. For example, a formed glass article can be formed by molding or shaping a glass sheet to provide the desired 3D shape. Structures of laminated glass articles according to embodiments are shown in FIG. 1A and FIG. 1B, which schematically depict laminated glass articles having 2n+1 layers, where n is the number of clad layers. In various embodiments, a glass layer can comprise a glass material, a glass-ceramic material, or a combination thereof. In the embodiment shown in FIG. 1A, the laminated glass article 100 comprises a core layer 110 and n clad layers 121a-122b. In FIG. 1A, clad layers, such as 121a and 122a, on one side of the core layer has a corresponding clad layer, 121b and 122b, on the opposing side of the core layer 110. In FIG. 1A each of the clad layers 121a-122b are shown as having substantially the same thickness. However, it should be understood that in other embodiments each of the clad layers 121a-122b may have different thicknesses that may be modified to control the stress profile of the laminated glass article 100.

In some embodiments, the interfaces between the clad layer 121a and the core layer 110 and/or between the clad layer 121b and the core layer 110 (or between other adjacent glass layers) are free of any bonding material such as, for example, an adhesive, a coating layer, or any non-glass material added or configured to adhere the respective glass layers to each other. Thus, the clad layers 121a and 121b are fused or applied directly to the core layer 110 or are directly adjacent to the glass core layer 110. In some embodiments, the laminated glass article comprises one or more intermediate layers disposed between the core layer 110 and the clad layers 121a and 121b. For example, the intermediate layers comprise intermediate glass layers and/or diffusion layers formed at the interface of the core layer 110 and the clad layers 121a and 121b (e.g., by diffusion of one or more components of the glass core and glass cladding layers into the diffusion layer). In some embodiments, the laminated glass article comprises a glass-glass laminate (e.g., an in situ fused multilayer glass-glass laminate) in which the interfaces between directly adjacent glass layers are glass-glass interfaces.

In embodiments, corresponding clad layers may have similar thicknesses. In the embodiment shown in FIG. 1A, any number of clad layers may be positioned between clad layers 121a and 122a, and clad layers 121b and 122b. The number of clad layers is limited only by the desired thickness of the laminated glass article 100 and the desired stress profile. In embodiments, adjacent layers (e.g., directly adjacent layers) have contrasting ion exchange diffusivity. As used herein, ion exchange diffusivity can be defined as the interdiffusion or mutual diffusion coefficient for ions involved in ion exchange processes. Mutual diffusion or interdiffusion of ions can be described by Fick's 2^{nd} law which, in one dimension, is as follows:

$$\frac{\partial c}{\partial t} = \frac{\partial J}{\partial x} = \frac{\partial }{\partial x} ( D \frac{\partial c}{\partial x} )$$

where x is the coordinate in glass thickness direction, c is the concentration of ions, such as, for example, K⁺, J is the concentration flux, and D is the effective mutual diffusivity as defined in J. Crank, THE MATHEMATICS OF DIFFUSION, 2nd ed., Oxford Science Publications (2001). As used herein, adjacent means that the layers are laminated on one another and are in physical contact with each other or with a diffusion layer formed therebetween. For example, in some embodiments, the core layer 110 may have higher ion exchange diffusivity than at least one of the clad layers 121a and 121b. In other embodiments, the core layer 110 may have lower ion exchange diffusivity than at least one pair of the clad layers 121a and 121b. In some embodiments, the core layer 110 may not be ion exchangeable.

In embodiments, the glass composition of each clad layer 121a-122b may be the same. In other embodiments, the glass composition of corresponding pairs of clad layers (such as pair 121a and 121b and pair 122a and 122b) may be the same, but the glass composition of different pairs of clad layers may be different. For example, in embodiments, clad layers 121a and 121b may have the same glass composition and clad layers 122a and 122b may have the same glass composition, but the glass composition of clad layers 121a and 121b may differ from the glass composition of clad layers 122a and 122b. In yet other embodiments, each of the clad layers 121a-122b may have different glass compositions. Therefore, in embodiments, adjacent clad layers may have contrasting ion exchange diffusivity.

FIG. 1B schematically depicts a laminated glass article 100 where n=1. The laminated glass article 100 comprises a core layer 110 and two clad layers 121a and 121b. In the embodiment shown in FIG. 1B, the clad layers 121a and 121b have substantially the same or the same thicknesses. However, it should be understood that the clad layers 121a and 121b may have differing thicknesses depending on the desired stress profile of the laminated glass article 100. In embodiments, the core layer 110 comprises higher ion exchange diffusivity than one or more of the clad layers 121a and 121b. In other embodiments, the core layer 110 comprises lower ion exchange diffusivity than one or more of the clad layers 121a and 121b. In embodiments, the core layer may not be ion exchangeable. In some embodiments, the clad layers 121a and 121b comprise the same ion exchange diffusivity. In other embodiments, the clad layers 121a and 121b comprise different ion exchange diffusivity.

The laminated glass of embodiments, such as laminated glass article 100 disclosed above, may be formed by any suitable process. In embodiments, the laminated glass article 100 may be formed using an overflow fusion process, such as the process disclosed in U.S. Pat. No. 4,214,886, which is incorporated herein by reference in its entirety.

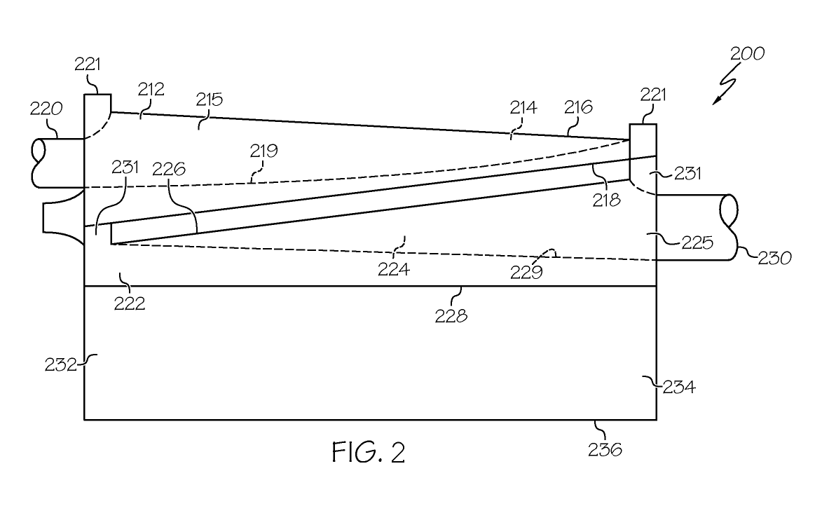

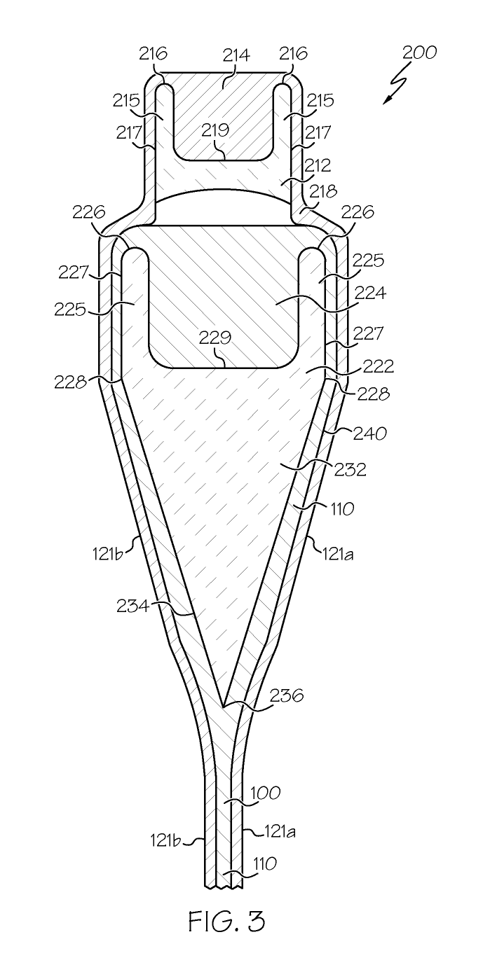

Referring now to FIGS. 2 and 3, an embodiment of apparatus 200 for forming laminated glass is shown. The apparatus 200 includes an upper distributor 212 positioned centrally over a lower distributor 222. The upper distributor 212 has a channel 214 formed longitudinally therealong bounded by sidewalls 215 having longitudinally linearly extending upper dam or weir surfaces 216 and outer sidewall surfaces 217 which terminate at their lower ends 218 in spaced relation above the lower distributor 222. The channel 214 has a sloping bottom surface 219, which tapers upwardly from an inlet end of the distributor fed by a glass delivery pipe 220, to the weir surfaces 216 at the opposite end of the distributor. A pair of end dams 221 extend across channel 214 and limit the longitudinal extent of the overflow therefrom.

The lower distributor 222 is also provided with an upwardly open longitudinally extending overflow channel 224 bounded by sidewalls 225 having longitudinally extending linear upper weir or dam surfaces 226 and substantially vertical outer sidewall surfaces 227. The channel 224 is provided with a sloping bottom surface 229 that extends upwardly from an inlet end provided with a glass delivery pipe 230 to the upper weir surfaces 226 at the opposite end of the distributor 222. A pair of end dams 231, which extend across the ends of overflow channel 224, not only confine the longitudinal flow over weir surfaces 226, but also provide a minimum space between the bottom edges 218 of the outer sidewall surfaces 217 of upper distributor 212 and the upper weir or dam surfaces 226 of lower distributor 222 allowing for the overflow of glass from the lower distributor. The upper and lower distributors are independently supported, and they may be adjusted relative to each other as desired. It will be noted that the lower edges 218 of the sidewalls 215 of upper distributor 212 are substantially parallel to the upper weir surfaces 226 of the lower distributor 222.

The lower distributor 222 has a wedge-shaped sheet glass forming member portion 232 provided with a pair of downwardly converging forming surfaces 224 that communicate at their upper ends with the lower ends 228 of outer sidewall surfaces 227, and convergingly terminate at their lower end in a root portion or draw line 236.

In the operation of the apparatus shown in FIGS. 2 and 3, molten core layer glass 110 is delivered to the inlet end of channel 224 by means of glass delivery pipe 230. A low effective head of the core layer glass 110 is maintained and accordingly the molten material flows into the channel 224 without surge or agitation. The molten glass then wells upwardly over the parallel upper dam or weir surfaces 226 of the channel 224, divides, and flows down the outer side surfaces 227 of each sidewall 225, and then flows downwardly along each of the oppositely disposed converging forming surfaces 234 of the glass forming portion 232. Simultaneously, molten clad glass 121 is delivered to the inlet end of channel 214 by means of glass delivery pipe 220 wherein the molten material wells over the parallel upper dam or weir surfaces 216 of the channel 214, divides, and flows down each outer sidewall surface 217 of the sidewalls 215 and onto the upper surface of the core layer 110, where it flows downwardly along outer surface portions 240 of the core layer 110. At the bottom of the wedge-shaped sheet forming member portion 232, the separate laminated flows rejoin to form a single composite or laminated sheet 100 having a core layer 110 and clad layers 121a and 121b on each side of the core layer 110.

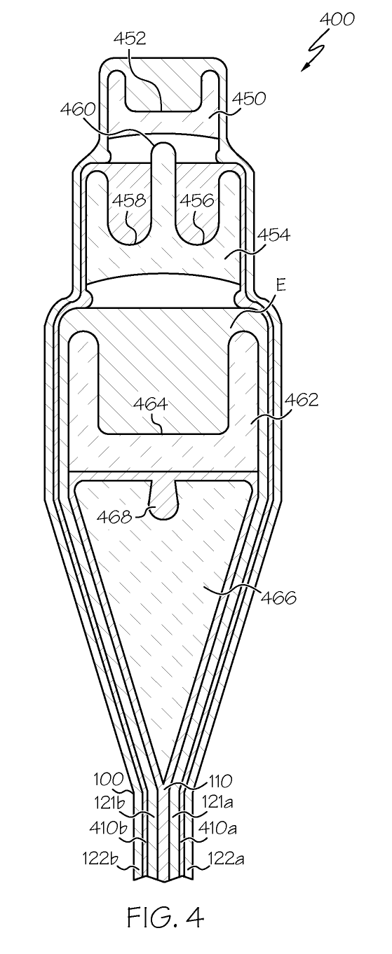

Referring now to FIG. 4, an embodiment of forming apparatus 400 is shown for forming a seven layer laminated glass article 100 comprising a core layer 110, a first set of clad layers 121a and 121b on each side of the core layer, a second set of clad layers 410a and 410b on opposite sides of the first set of clad layers 121a and 121b, and outer clad layers 122a and 122b overlying the second set of clad layers 410a and 410b.

In the embodiment shown in FIG. 4, the uppermost distributor 450 has a channel 452 from which clad glass overflows and runs down opposite sides to form a clad layer on glass overflowing distributor 454 there below. The distributor 454 is shown having two overflow channels 456, 458 divided by a raised central wall 460 such that clad layer 410a is fed to channel 456 and only overflows on one outside wall of distributor 454 whereas clad layer 410b is fed to channel 458 and overflows the opposite sidewall of distributor 454. A further distributor 462, positioned below distributor 454, has a channel 464 that feeds clad layers 121a and 121b downward over the opposed sidewalls of the channel. Finally, a distributor 466 positioned below distributor 462 has a channel 468 that feeds core layer glass 110 downward over the converging sidewalls of the distributor 466. Thus, channel 468 distributes core layer glass down opposed sides of distributor 466, channel 464 supplies a first set of clad layers 121a, 121b over the outer surface of both flows of the core layer glass 110, channel 456 of distributor 454 supplies a clad layer 410a over the outer surface of one flow of the first set of clad layers 121a, whereas channel 458 of distributor 454 supplies a further clad layer 410b over the surface of the other of the first set of clad layers 121b, and finally channel 452 of distributor 450 supplies clad layers 122a, 122b over the outer surfaces of clad layers 410a, 410b, respectively to form the seven layer laminated glass article 100 withdrawn from the bottom of distributor 400. FIG. 4 is merely illustrative of how various combinations of distributors may be positioned one above another, and it will be appreciated that the various combinations of distributors may be used.

Once the laminated glass article 100 has been formed, compressive stress may be introduced in the laminated glass article 100 by chemical strengthening processes, such as an ion exchange treatment. Although any suitable ion exchange treatment may be used, in embodiments, ion exchange treatments include immersing the laminated glass article in a molten salt bath containing larger ions, such as K⁺ and Na⁺, to be exchanged with smaller ions in the glass matrix, such as Na⁺ and Li⁺. By way of example, ion exchange of alkali metal-containing glasses may be achieved by immersion in at least one molten salt bath containing a salt, such as nitrates, sulfates, and chlorides of the larger alkali metal ion. For example, in some embodiments, the molten salt bath is molten KNO₃, molten NaNO₃, or mixtures thereof. In some embodiments, the temperature of the molten salt bath is from about 380° C. to about 450° C., and immersion times are from about 2 hours to about 16 hours. In other embodiments, ion exchange treatments include applying an ion exchange medium to one or more surfaces of the laminated glass article. The ion exchange medium comprises a solution, a paste, a gel, or another suitable medium comprising larger ions to be exchanged with smaller ions in the glass matrix. By replacing smaller ions in the glass matrix with larger ions at the surface of the laminated glass article, compressive stress is formed as the glass cools and the larger ions are pushed together. Such compressed surfaces result in strengthened glasses that are more resistant to damage than non-strengthened glass.

In some embodiments, the molten salt bath comprises a substantially pure molten salt. For example, the molten salt bath comprises substantially pure or pure KNO₃ with an effective mole fraction of K⁺ of at least about 95%, at least about 98%, at least about 99%, or about 100%. In other embodiments, the molten salt bath comprises a poisoned salt. For example, the molten salt bath comprises poisoned KNO3 with an effective mole fraction of K⁺ of less than about 90%, less than about 85%, or about 80%. The effective mole fraction of K⁺ is calculated by dividing the mole percent of K⁺ by the sum of the mole percents of Na⁺ and K⁺. In some embodiments, the ion exchange process comprises two ion exchange processes. A first ion exchange process comprises exposing the laminated glass article to a first salt comprising a substantially pure salt. A second ion exchange process comprises exposing the laminated glass article to a second salt comprising a poisoned salt.

It may be desirable to increase the compressive stress in a glass, for example, to improve the damage resistance of the glass. In embodiments, the maximum compressive stress in the laminated glass article may be from about 300 MPa to about 1000 MPa, such as from about 500 MPa to about 900 MPa. In some embodiments, the maximum compressive stress in the laminated glass article may be from about 600 MPa to about 800 MPa, such as from about 650 MPa to about 750 MPa.

In addition to compressive stress, depth of the compressive stress layer, also referred to as DOL, contributes to the strength of the laminated glass article. DOL represents the distance in the thickness direction that the compressive stress layer extends into the glass article, measured from an outer surface of the glass article. For example, generally the deeper the DOL the more resistant a glass is to damage. However, when DOL is too deep into the glass, functionality may suffer. Therefore, the DOL should be selected to balance the desired strength of the glass and the functionality of the glass. For instance, in embodiments, the DOL is greater than the thickness of an outermost clad layer so that ions diffuse into a layer adjacent to the outermost clad layer, thereby allowing a difference in ion exchange diffusivity to be used to manipulate the stress profile. In embodiments, the DOL may be from about 8 μm to 150 μm, such as from about 10 μm to about 120 μm. In other embodiments, the DOL may be from about 50 μm to about 150 μm, such as from about 70 μm to about 150 μm. In yet other embodiments, the DOL may be from about 15 μm to about 100 μm, such as from about 20 μm to about 90 μm. In yet other embodiments, the DOL may be from about 25 μm to about 85 μm, such as from about 30 μm to about 80 μm. In still other embodiments, the DOL may be from about 35 μm to about 75 μm, such as from about 40 μm to about 70 μm. In some embodiments, the DOL is from about 45 μm to about 60 μm. In some embodiments, the DOL may be from about 8 μm to about 80 μm, such as from about 10 μm to about 60 μm, or even from about 25 μm to about 50 μm.

As mentioned above, compressive stress and DOL have traditionally been considered when determining the damage resistance of a laminated glass article. However, increasing compressive stress and DOL in a glass having a stress profile that is shaped as a complimentary error function or linearly shaped can lead to glass frangibility that is beyond acceptable limits.

Frangible behavior (also referred to herein as “frangibility”) refers to extreme fragmentation behavior of a glass and is described in U.S. Pat. No. 8,075,999, which is incorporated herein by reference in its entirety. Frangible behavior is the result of development of excessive internal or central tension within the laminated glass, resulting in forceful or energetic fragmentation of the laminated glass article upon fracture. In laminated or chemically strengthened (e.g., strengthened by ion exchange) glass articles, frangible behavior can occur when the balancing of compressive stresses in a surface or outer region of the laminated glass with tensile stress in the center of the glass provides sufficient energy to cause multiple cracks branching with ejection or “tossing” of small glass pieces and/or particles from the article. The velocity at which such ejection occurs is a result of the excess energy within the glass article, stored as central tension.

The frangibility of a glass article is a function of central tension and compressive stress. In particular, the central tension within a glass article can be estimated from the compressive stress for a glass having a stress profile that is shaped as a complimentary error function or linearly shaped. Compressive stress is measured near the surface (i.e., within 100 μm), giving a maximum compressive stress value and a measured DOL. The relationship between compressive stress (CS) and central tension (CT) is given by the expression:

CT≈(CS·DOL)/(t−2DOL) (1),

wherein t is the thickness of the glass article. Unless otherwise specified, central tension CT and compressive stress CS are expressed herein in megaPascals (MPa), whereas thickness t and depth of layer DOL are expressed in millimeters. The depth of the compression layer DOL and the maximum value of compressive stress CS that should be designed into or provided to a glass article are limited by such frangible behavior. Consequently, frangible behavior is one consideration to be taken into account in the design of various glasses.

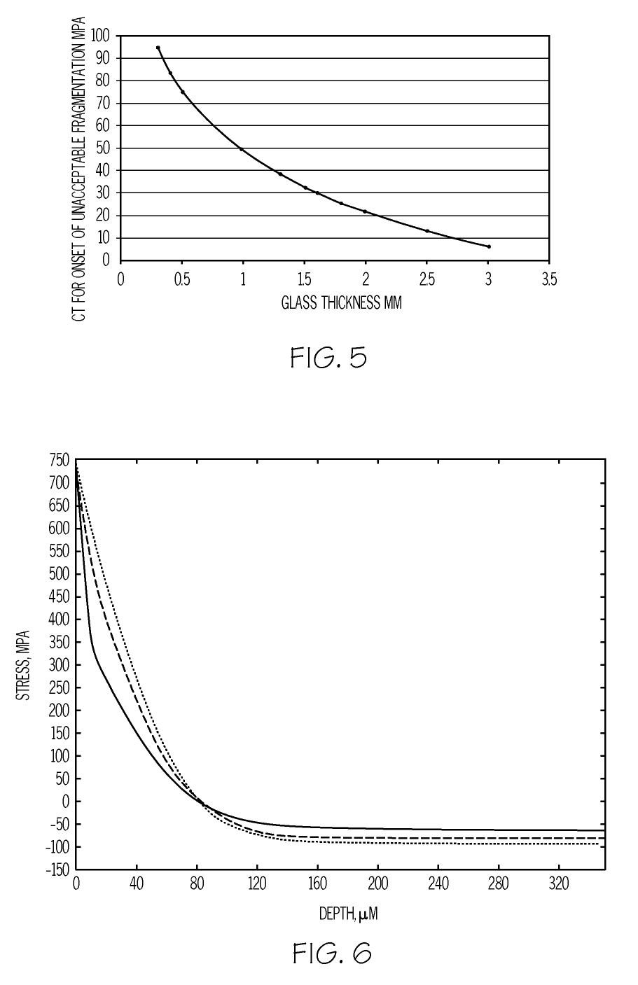

Accordingly, to avoid frangibility, a glass may be designed to have a central tension at or below a critical or threshold central tension for the glass article to avoid frangibility upon impact with another object, while taking both compressive stress and DOL into account. Referring to FIG. 5, a threshold central tension at which the onset of unacceptable frangible behavior occurs is plotted as a function of thickness t. The threshold central tension is based upon experimentally observed behavior. The threshold central tension (TCT) may be described by the equation:

TCT(MPa)=−38.7 (MPa/mm)·ln(t)(mm)+48.2 (MPa) (2).

Accordingly, depending on the thickness of the glass, central tension may be controlled along with compressive stress and DOL. Heretofore the stress profiles of strengthened glass generally was thought to be set and, thus, it was thought that central tension could only be modified by decreasing at least one of the compressive stress and DOL. However, by forming a laminated glass article having contrasting ion exchange diffusivity between adjacent layers of the laminated glass article, the central tension may be modified without sacrificing compressive stress or DOL.

Referring again to FIG. 1A, to provide the contrast in ion exchange diffusivity, in embodiments, the core layer 110 and at least one clad layer 121a-122b may be made from differing glass compositions so that target ions, such as K⁺ and Na⁺, in an ion exchange medium diffuse more quickly into the at least one clad layer 121a-122b than the core layer 110. In other embodiments, the core layer 110 and the at least one clad layer 121a-122b may be made from differing glass compositions so that the target ions in the ion exchange solution diffuse more quickly into the core layer 110 than the at least one clad layer 121a-122b. Using this contrasting ion exchange diffusivity between the core layer 110 and at least one clad layer 121a-122b allows balancing of a stress profile of the laminated glass article 100 so that the laminated glass article 100 meets the requirements of high surface compressive stress, DOL, and central tension.

In some embodiments, the core layer 110 has higher ion exchange diffusivity than the clad layers 121a-122b, and the target ions of the ion exchange bath, such as K⁺, diffuse slowly in the clad layers 121a-122b and accelerate significantly when they reach the core layer. Thus, a single-step ion exchange process is capable of generating various engineered stress profiles that have high surface compressive stress and a deep DOL when compared to conventional glasses that have a stress profile shaped as a complimentary error function or linearly shaped.

Referring now to FIG. 6, graphical depictions of stress profiles for three laminated glass articles having a core layer and two clad layers are shown. In the stress profiles described herein, compressive stress is shown on the positive y-axis, and tensile stress is shown on the negative y-axis. However, the values given for tensile stress are positive values (e.g., the magnitude of the values shown in the stress profiles). The laminated glass articles used to produce the graph of FIG. 6 all had a DOL of 80 μm, clad thickness of 10 μm per clad layer, and a total laminated glass article thickness of 0.7 mm. For the embodiments of the three laminated glass articles shown in FIG. 6, the ion exchange diffusivity of the clad layers, D₁, was kept constant at 120 μm²/hr, and the ion exchange diffusivity of the core layer, D₀, was varied to achieve various contrasting ion exchange diffusivities between the core layer and the clad layers, as measured by the ratio D₀/D₁. In FIG. 6 (as well as in the other figures that graphically depict stress profiles), the central tension in MPa for each sample is the point where the stress stops decreasing and begins to plateau.

Sample 1, as indicated by the dotted line in FIG. 6, did not have contrasting ion exchange diffusivity (i.e., D₀/D₁=1). Sample 1 was ion exchanged by immersion in a KNO₃ molten bath for a period of 660 minutes at 470° C. As can be seen in FIG. 6, the maximum compressive stress of Sample 1 was about 740 MPa and was at the surface of the laminated glass article (i.e., depth of 0 μm). In Sample 1 the compressive stress gradually decreased from the surface of the laminated glass article to the DOL, 80 μm. The central tension of Sample 1 was about 94 MPa. However, as indicated by the curve depicted in FIG. 5, the threshold central tension (TCT) for a 0.7 mm thick glass article is about 63 MPa. Thus, the central tension of Sample 1 exceeded the TCT for a 0.7 mm thick glass article, which resulted in unacceptable frangibility.

Creating a contrast between the ion exchange diffusivity of the core layer and the ion exchange diffusivity of the clad layers by increasing the ion exchange diffusivity of the core layer resulted in the stress profile shifting to the left and the central tension of the laminated glass article was reduced even when the DOL and compressive stress remained constant. Sample 2 in FIG. 6, which is represented by a dashed line, had the same maximum compressive stress as Sample 1, about 740 MPa, at its surface. Sample 2 also had a DOL of about 80 μm, which was the same as Sample 1. However, the ion exchange diffusivity of the core layer was increased to 240 μm²/hour, yielding D₀/D₁=2, which increased the rate at which the compressive stress decreased, particularly in the clad layers. Additionally, the glass of Sample 2 was ion exchanged by immersing the laminated glass article in a molten bath of KNO₃ for 360 minutes at 470° C., which was a significant decrease in the ion exchange duration when compared to Sample 1. This moderate contrast in ion exchange diffusivity between the core layer and the clad shifted the stress profile so that the central tension of the glass of Sample 2 was about 81 MPa. This central tension was still above the threshold central tension of 63 MPa for a 0.7 mm thick laminated glass as shown in the curve of FIG. 5, but it indicates that by increasing the D₀/D₁ ratio, central tension of a laminated glass article may be reduced without sacrificing compressive stress or DOL.

Sample 3 in FIG. 6, which is indicated by a solid line, further shows that providing contrast in ion exchange diffusivity between the core layer and the clad layers shifts a stress profile to the left and can be used to provide a laminated glass article that is capable of meeting desired compressive stress, DOL, and frangibility limitations. Sample 3 of FIG. 6 had a maximum compressive stress of about 740 MPa at its surface, and a DOL of 80 μm, which were the same as the compressive stress and DOL of Sample 1 and Sample 2. However, the ion exchange diffusivity in the core layer of the glass of Sample 3 was increased to 600 μm²/hour, yielding a ratio of D₀/D₁=5. The laminated glass article of Sample 3 was ion exchanged by immersing the laminated glass article in a molten bath of KNO₃ for 170 minutes at a temperature of 470° C. As can be seen in FIG. 6, the compressive stress decreased more rapidly, particularly in the clad layers. This shifted the stress profile to the left to an extent that the central tension of Sample 3 is about 60 MPa, which is below the threshold central tension of 63 MPa for a 0.7 mm thick laminated glass article as shown in FIG. 5, indicating that the frangibility of the laminated glass article of Sample 3 was acceptable. Thus, the laminated glass article of Sample 3 was able to meet industrial frangibility requirements and maintain compressive stress and DOL of glasses previously thought to be incapable of meeting the industrial frangibility standards.

Without being bound by any particular theory, it is believed that by providing a laminated glass article with a core layer that has higher ion exchange diffusivity than the clad layers, the target ions, such as K⁺, from an ion exchange solution will diffuse relatively slowly through the clad layer and accelerate when they reach the core layer. Thus, regions of the clad layer closer to the surface of the clad layer will have high residency time with the target ions by virtue of being in contact with the ion exchange solution, thereby allowing more target ions to replace smaller ions in the glass matrix and increase the compressive stress. However, regions of the clad layer further from the surface will have lower residence time with target ions compared to regions of the clad layer closer the surface. Regions of the clad layer farther from the surface are also disadvantaged by the relatively high ion exchange diffusivity of the core. The target ions accelerate when they reach the core; thus, the target ions are pulled from the regions of the clad layers closest to the core, thereby reducing the residency time of the target ions at regions of the clad layer closest to the core. Accordingly, there is a large difference in residence time of the target ions at the surface of the clad layer and at a portion of the clad layer directly adjacent to the core, which caused the increased rate at which the compressive stress decreased as seen in Sample 3 of FIG. 6. However, because of the high ion exchange diffusivity of the target ions in the core, the graph of Sample 3 in FIG. 6 rapidly plateaus, allowing the glass article of Sample 3 to have a low central tension compared to the glass article samples with lower D₀/D₁ ratios.

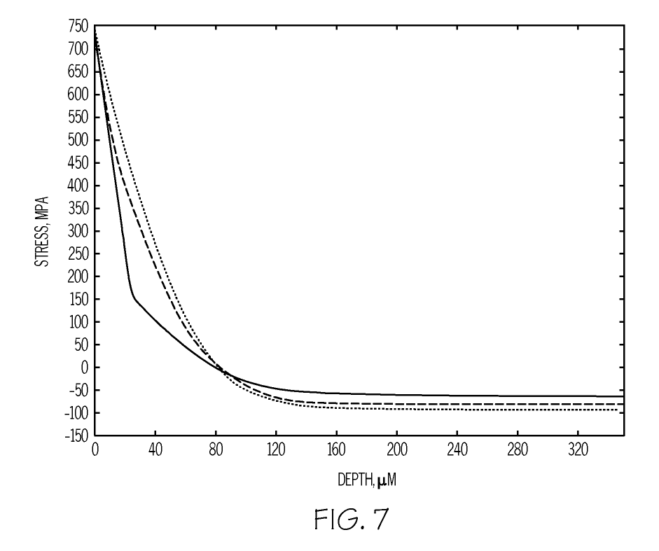

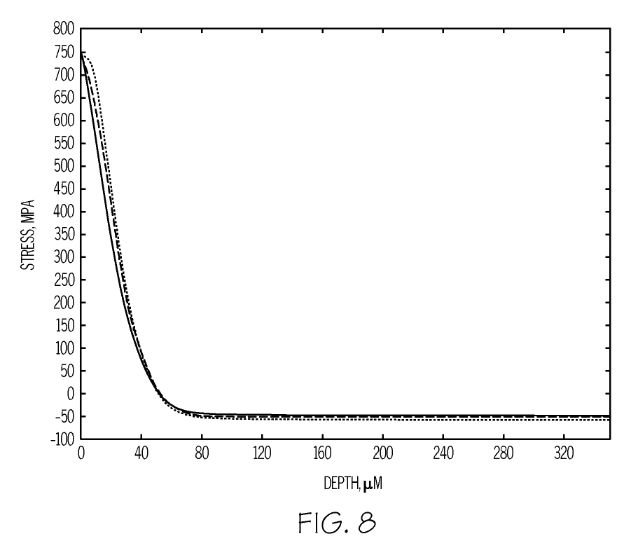

Referring now to FIG. 7, two additional samples of three-layer glass laminates were provided. The dotted line in FIG. 7 indicates the glass article of Sample 1 as described above in regard to FIG. 6, which is used as a reference sample where D₀/D₁=1. Like Samples 1-3, the stress profiles of the glass of Sample 4 and Sample 5, which are indicated by a dashed line and a solid line, respectively, in FIG. 7 each have a maximum compressive stress at their surface of about 740 MPa, a DOL of about 80 μm, and a total thickness of the laminated glass article of about 0.7 mm. Further, like Samples 1-3, the ion exchange diffusivity of the clad layer, D₁, in Sample 4 and Sample 5 is 120 μm²/hour. However, unlike Samples 1-3, the clad layers of Sample 4 and Sample 5 are each 25 μm thick.

In Sample 4, the ion exchange diffusivity of the core layer was 240 μm²/hour, yielding D₀/D₁=2. The glass article of Sample 4 was ion exchanged by immersion in a molten KNO₃ bath for a duration of 420 minutes at a temperature of 470° C. As shown in FIG. 7 the compressive stress decreased rapidly through the clad layer and decreased more slowly in the core. This caused a shift in the stress profile of Sample 4 to the left of the graph when compared to the stress profile of Sample 1, where D₀/D₁=1. The central tension of Sample 4 was about 78 MPa, which is still above the threshold central tension of 63 MPa as shown in FIG. 5 for a glass article with a thickness of 0.7 mm.

In Sample 5, the ion exchange diffusivity of the core layer was 600 μm²/hour, yielding D₀/D₁=5. The glass article of Sample 5 was ion exchanged by immersion in a molten KNO₃ bath for a duration of 250 minutes at a temperature of 470° C. As shown in FIG. 7 the compressive stress decreased rapidly through the clad layer and decreased more slowly in the core. This causes a shift in the stress profile of Sample 5 to the left of the graph when compared to the stress profile of Sample 1, where D₀/D₁=1, and as compared to Sample 4. The central tension of Sample 5 is about 60 MPa, which is below the threshold central tension of 63 MPa as shown in FIG. 5 for a glass with a thickness of 0.7 mm. Therefore, the glass article of Sample 5 meets the industrial frangibility requirements while maintaining a high compressive stress and DOL.

Thus, FIG. 7 shows, for example, that for laminated glass articles where the application allows, increasing the thickness of the clad layers that have contrasting ion exchange diffusivity with adjacent layers facilitate a decreased central tension, which allows the laminated glass article to meet industrial frangibility requirements while maintaining high compressive stress and DOL.

The above embodiments shown in FIG. 6 and FIG. 7 show contrasting ion exchange diffusivity where there was higher ion exchange diffusivity in the core layer than in the clad layers. However, in some embodiments the core layer has lower ion exchange diffusivity than the clad layers. In these embodiments, the target ions of the ion exchange bath, such as K⁺, diffuse relatively quickly in the clad layers and decelerate significantly when they reach the core. Thus, only a single-step ion exchange is capable of generating the various engineered stress profiles that have high surface compressive stress and a deep depth of layer when compared to conventional glass articles that have a stress profile shaped as a complimentary error function or linearly shaped.

Referring now to FIG. 8, graphical depictions of stress profiles for three laminated glass articles having a core layer and two clad layers are provided. The laminated glass articles used to produce the graph of FIG. 8 all had a DOL of 50 μm, clad thickness of 8 μm per clad layer, and a total laminated glass thickness of 0.7 mm. For the embodiments of the three laminated glass articles shown in FIG. 8, the ion exchange diffusivity of the clad layers, D₁, was kept constant at 120 μm²/hr, and the ion exchange diffusivity of the core, D₀, was varied to achieve contrasting ion exchange diffusivities between the core layer and the clad layers.

Sample 6, as indicated by the solid line in FIG. 8, did not have contrasting ion exchange diffusivity (i.e., D₀/D₁=1). Sample 6 was ion exchanged by immersion in a KNO₃ molten bath for a period of 180 minutes at 440° C. As can be seen in FIG. 8, the maximum compressive stress of Sample 6 was about 740 MPa and was at the surface of the laminated glass article (i.e., depth of 0 μm). In Sample 6 the compressive stress decreased from the surface of the laminated glass article to the depth of the compressive stress layer, 50 μm. The central tension of Sample 6 was about 49 MPa, which was below the TCT for a 0.7 mm thick laminate glass article as shown in FIG. 5.

Creating a contrast between the ion exchange diffusivity of the core layer and the ion exchange diffusivity of the clad layers, where D₀/D₁<1, the stress profile is shifted to the right and the compressive stress of the laminated glass article remains high deeper into the DOL. Sample 7 in FIG. 8, which is indicated by a dashed line, had the same maximum compressive stress as Sample 6, about 740 MPa, at its surface. Sample 7 also had a DOL of about 50 μm, which is the same as Sample 6. However, the ion exchange diffusivity of the core layer was decreased to 60 μm²/hour so that D₀/D₁=0.5, which allowed the compressive stress to decrease less rapidly through the core. Additionally, the glass of Sample 7 was ion exchanged by immersing the laminated glass article in a molten bath of KNO₃ for 330 minutes at 440° C. This moderate contrast in ion exchange diffusivity between the core layer and the clad provided a shift of the stress profile to the right in the graph of FIG. 8 yielding a compressive stress remained high deeper into the DOL.

Sample 8 in FIG. 8, which is indicated by a dotted line, further shows that providing the a contrast in ion exchange diffusivity between the core layer and the clad layers, where D₀/D₁<1, shifted a stress profile to the right and can be used to provide high compressive stress deeper into the DOL. Sample 8 of FIG. 8 has a maximum compressive stress of about 740 MPa at its surface, and a DOL of 50 μm, which are the same as the compressive stress and DOL of Sample 6 and Sample 7. However, the ion exchange diffusivity in the core layer of the glass of Sample 8 was decreased to 24 μm²/hour, yielding D₀/D₁=0.2. The laminated glass article of Sample 8 was ion exchanged by immersing the laminated glass article in a molten bath of KNO₃ for 770 minutes at a temperature of 440° C. As can be seen in FIG. 8, the compressive stress decreased more slowly, particularly in the clad layers. This decrease in rate at which the compressive stress decreases shifts the stress profile to the right in the graph of FIG. 8 and allowed the compressive stress to remain high deeper into the DOL.

Without being bound by any particular theory, it is believed that by providing a laminated glass article with a core layer that has lower ion exchange diffusivity than the clad layers, the target ions, such as K⁺, from an ion exchange solution will diffuse relatively quickly through the clad layer and decelerate when they reach the core layer. Thus, the residence time of target ions at regions throughout the clad layer are more consistent and decrease the rate at which the compressive stress decreases in the clad portions of the laminated glass article. Thus, in applications where it is desired to have high compressive stress deep into the DOL, laminated glass where D₀/D₁<1 is advantageous.

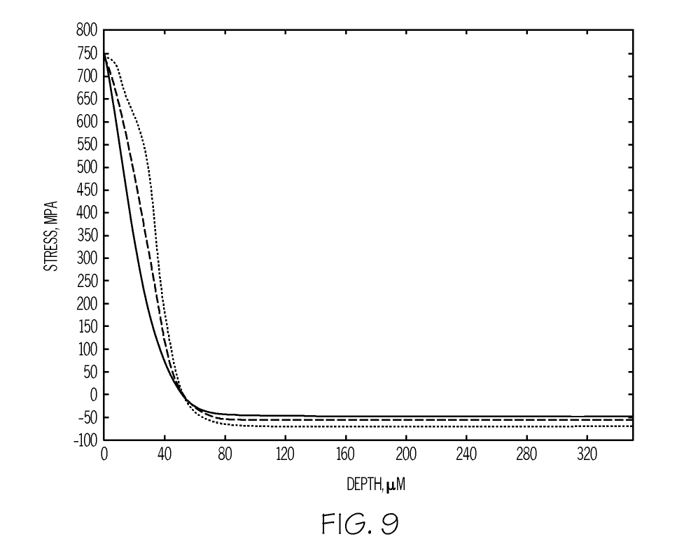

The above is further elaborated with reference to FIG. 9. In FIG. 9, two additional samples (Sample 9 and Sample 10) of three-layer laminated glass article were provided. The solid line in FIG. 9 indicates the glass of Sample 6 as described above in regard to FIG. 8, which was used as a reference sample where D₀/D₁=1. Like Samples 6-8, the glass of Sample 9 and Sample 10, which are indicated by a dashed line and a dotted line, respectively, in FIG. 9, each had a maximum compressive stress at their surface of about 740 MPa, a DOL of about 50 μm, and a total thickness of the laminated glass article of about 0.7 mm. Further, like Samples 6-8, the ion exchange diffusivity of the clad layer, D₁, in Sample 9 and Sample 10 was 120 μm²/hour. However, unlike Samples 6-8, the clad layers of Sample 9 and Sample 10 were 25 μm thick.

In Sample 9, the ion exchange diffusivity of the core layer was 120 μm²/hour, yielding D₀/D₁=0.5. The glass article of Sample 9 was ion exchanged by immersion in a molten KNO₃ bath for a duration of 330 minutes at a temperature of 440° C. As shown in FIG. 9 the compressive stress decreased less rapidly through the clad layer and more rapidly in the core as compared to Sample 6. This causes a shift in the stress profile of Sample 9 to the right when compared to the stress profile of Sample 6, where D₀/D₁=1. Thus, the glass article of Sample 9 had a compressive stress of about 350 MPa at a depth of about 40 μm, whereas the glass article of Sample 6 had a compressive stress of about 40 MPa at a depth of about 40 μm.

In Sample 10, the ion exchange diffusivity of the core layer was 24 μm²/hour, yielding D₀/D₁=0.2. The glass article of Sample 10 was ion exchanged by immersion in a molten KNO₃ bath for a duration of 480 minutes at a temperature of 440° C. As shown in FIG. 9 the compressive stress decreased less rapidly through the clad layer and decreased more rapidly in the core. This caused a shift in the stress profile of Sample 10 to the right of the graph when compared to the stress profile of Sample 6, where D₀/D₁=1, and Sample 9. The glass article of Sample 10 had a compressive stress of about 510 MPa at a depth of about 40 μm, which is much greater than the compressive stress of both Sample 6 and Sample 9 at a depth of about 40 μm.

Thus, FIG. 8 and FIG. 9 show, for example, that for laminated glass articles where a high compressive stress is desired deep into the compressive stress layer, one may increase the thickness of the clad layers and provide a contrasting ion exchange diffusivity where D₀/D₁<1.

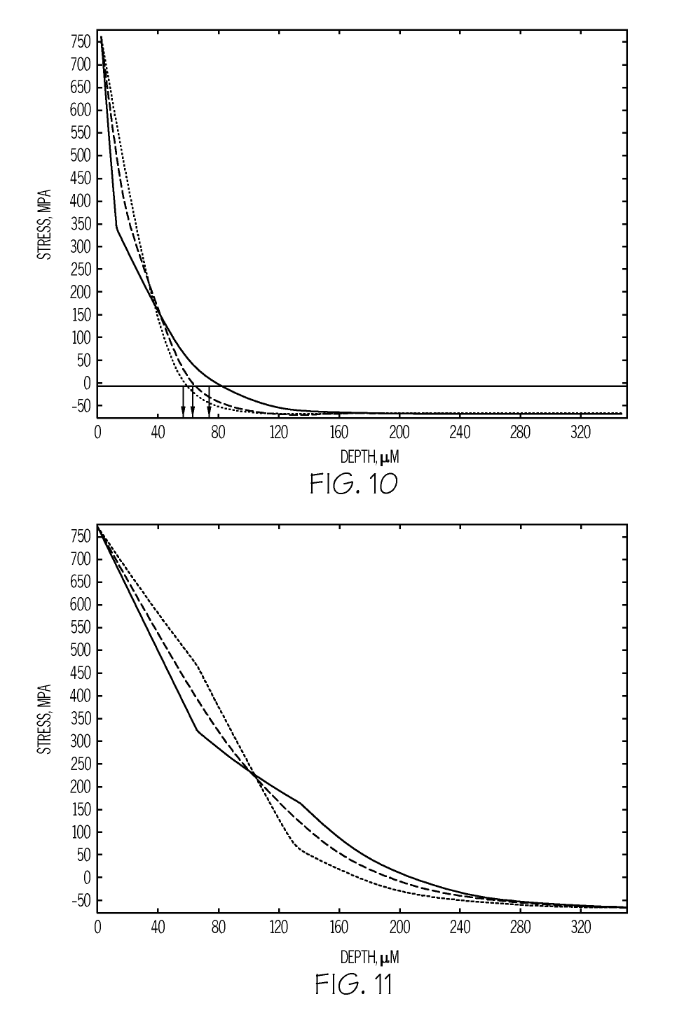

In the above embodiments compressive stress and DOL have been held constant and central tension or the depth of high compressive stress was modified by adjusting the D₀/D₁ ratio. However, it should be understood that any of these three variables (compressive stress, DOL, and central tension) may be modified while the other two are held constant. For example, and with reference to FIG. 10, compressive stress and central tension may be held constant and the DOL may be changed by modifying the D₀/D₁ ratio.

FIG. 10 graphically depicts stress profiles of three laminated glass articles having a core layer and two clad layers. In each of the glass article samples depicted in FIG. 10, the clad layers were each 10 μm thick, the laminated glass article was 0.7 mm thick, the maximum compressive stress at the surface of the laminated glass article was 776 MPa, and the central tension was 63 MPa, which is the threshold central tension for a 0.7 mm thick glass article as shown in FIG. 5. In each of the glass article samples depicted in FIG. 10, the ion exchange diffusivity of the clad layer was 120 μm²/hour and the ion exchange diffusivity of the core layer was modified to provide varying D₀/D₁ ratios.

In Sample 11, which is represented by a dotted line in FIG. 10, there was no contrast in ion exchange diffusivity between the core layer and the clad layers, thus D₀/D₁=1. This sample was ion exchanged by immersing the laminated glass article in a molten bath of KNO₃ for a duration of 260 minutes at a temperature of 440° C. As shown in FIG. 10, the slope of the stress profile was about the same as in Sample 1, and the DOL of Sample 11 is about 80 μm.

In Sample 12, which is represented by a dashed line in FIG. 10, the ion exchange diffusivity of the core layer was 240 μm²/hour, yielding D₀/D₁=2. This sample was ion exchanged by immersing the laminated glass article in a molten bath of KNO₃ for a duration of 210 minutes at a temperature of 440° C. As shown in FIG. 10, the slope of the stress profile is about the same as Sample 2, and the DOL of Sample 12 is about 66 μm.

In Sample 13, which is represented by a solid line in FIG. 10, the ion exchange diffusivity of the core layer was 600 μm²/hour, yielding D₀/D₁=5. This sample was ion exchanged by immersing the laminated glass article in a molten bath of KNO₃ for a duration of 170 minutes at a temperature of 440° C. As shown in FIG. 10, the slope of the stress profile is about the same as Sample 3, and the DOL of Sample 13 is about 57 μm.

Accordingly, FIG. 10 shows that DOL may be modified by varying the contrasting ion exchange diffusivity between the core layer and the clad layers while the compressive stress and central tension are held constant. It should be understood from the above disclosure that any of the compressive stress, DOL, and central tension may be modified while holding the other variables constant by varying the contrasting ion exchange diffusivity between adjacent layers of the laminated glass article.

Although the above embodiments have been directed to laminated glass articles having a core layer and two clad layers, it should be understood that a laminated glass article having any number of clad layers may be used. Referring now to FIG. 11, which graphically depicts the stress profiles of laminated glass articles having a core layer and four clad layers, each of the samples depicted in FIG. 11 had clad layers that were 20 μm thick, the thickness of the laminated glass article was 0.7 mm, the maximum compressive stress at the surface of the laminated glass article was 776 MPa, and the central tension was 63 MPa, which is the threshold central tension shown in FIG. 5 for a 0.7 mm thick glass. Additionally, the ion exchange diffusivity of the core, D₀, in each of the samples was 600 μm²/hour, and the ion exchange diffusivity of the first clad layer (i.e., the clad layers adjacent to the core), D₁, in each of the samples was 120 μm²/hour, yielding D₀/D₁=5 for each of the samples. The ion exchange diffusivity of the outer clad layers, D₂, was varied to achieve varying D₂/D₁ ratios.

In Sample 13, which is represented by a dashed line in FIG. 11, there was no contrast in the ion exchange diffusivity between the first clad layers and the second clad layers, thus D₂/D₁=1. The laminated glass article of Sample 13 was ion exchanged by immersing the laminated glass article in a molten KNO₃ bath for a duration of 270 minutes at a temperature of 470° C. As shown in FIG. 11 the stress profile of Sample 13 had a compressive stress that decreased relatively consistently through the clad layers and then the compressive stress decreased less rapidly as the target ions approach the core layer that has higher ion exchange diffusivity.

In Sample 14, which is represented by a dotted line in FIG. 11, the second clad layers had an ion exchange diffusivity of 60 μm²/hour, yielding D₂/D₁=0.5. The laminated glass article of Sample 14 was ion exchanged by immersing the laminated glass article in a molten KNO₃ bath for a duration of 300 minutes at a temperature of 470° C. As shown in FIG. 11 the stress profile of Sample 14 had a compressive stress that decreased less rapidly through the second clad layer of Sample 14 (i.e., from a depth of 0 μm to a depth of 20 μm) than the compressive stress in Sample 13. However, the compressive stress decreased more rapidly through the first clad layer of Sample 14 (i.e., from a depth of 20 μm to a depth of 40 μm) than the compressive stress in Sample 13. The compressive stress decreased at about the same rate through the core layer of Sample 13 and Sample 14.

In Sample 15, which is represented by a solid line in FIG. 11, the second clad layers had an ion exchange diffusivity of 240 μm²/hour, yielding D₂/D₁=2. The laminated glass article of Sample 15 was ion exchanged by immersing the laminated glass article in a molten KNO₃ bath for a duration of 250 minutes at a temperature of 470° C. As shown in FIG. 11 the stress profile of Sample 15 had a compressive stress that decreased more rapidly through the second clad layer of Sample 15 (i.e., from a depth of 0 μm to a depth of 20 μm) than the compressive stress in Sample 13. However, the compressive stress decreased less rapidly through the first clad layer of Sample 15 (i.e., from a depth of 20 μm to a depth of 40 μm) than the compressive stress in Sample 13. The compressive stress decreased at about the same rate through the core layer of Sample 13 and Sample 14.

FIG. 11 shows that the stress profiles of laminated glass articles may be modified by providing clad layers with contrasting ion exchange diffusivity from adjacent clad layers. As shown in FIG. 11, providing a second clad layer having a lower ion exchange diffusivity than an adjacent clad layer, such as shown in Sample 14, not only did the compressive stress reduce more slowly in that layer, but the compressive stress reduced more rapidly in an adjacent clad layer. For example, in Sample 14, having D₂/D₁=0.5 caused a slow decrease in the compressive stress in the second clad layer (i.e., from a depth of 0 μm to a depth of 20 μm) as compared to a laminated glass article where D₂/D₁=1, and a more rapid decrease in the compressive stress in the first clad layer (i.e., from a depth of 20 μm to a depth of 40 μm) when compared to a laminated glass article where D₂/D₁=1. However, providing a second clad layer having a higher ion exchange diffusivity than an adjacent clad layer, such as shown in Sample 15 caused a more rapid decrease in the compressive stress in that layer, but it also caused a slower decrease of the compressive stress in an adjacent clad layer. For example, in Sample 15, having D₂/D₁=2 caused a rapid decrease in compressive stress in the second clad layer (i.e., from a depth of 0 μm to a depth of 20 μm) as compared to a laminated glass article where D₂/D₁=1, and a slower decrease in the compressive stress in the first clad layer (i.e., from a depth of 20 μm to a depth of 40 μm) when compared to a laminated glass article where D₂/D₁=1. Thus, FIG. 11 shows that providing contrasting ion exchange diffusivity in adjacent clad layers affects the compressive stress reduction in adjacent layers regardless of the ion exchange diffusivity of the adjacent layer. For example, even though the first clad layers is Samples 13-15 have the same ion exchange diffusivity, when a second clad layer having a contrasting ion exchange diffusivity is provided adjacent to the first clad layer, the slope of the compressive stress reduction in the first clad layer is affected by the ion exchange diffusivity in the second clad layer.

Although exemplary embodiments of laminated glass articles have been identified above, it should be understood that the underlying principles may be applied to laminated glass articles regardless of the specific properties of those laminated glass articles. For example, in embodiments, the thickness of the laminated glass article may be from about 0.075 mm to about 4 mm, such as from about 0.3 mm to about 2 mm, such as from about 0.4 mm to about 1.75 mm. In other embodiments, the thickness of the laminated glass article may be from about 0.5 mm to about 1.5 mm, such as from about 0.6 mm to about 1.25 mm. In yet other embodiments, the thickness of the laminated glass article may be from about 0.7 mm to about 1 mm, such as from about 0.8 mm to about 0.9 mm.

In embodiments, the thickness of the clad layers may be from about 3 μm to about 100 μm, such as from about 5 μm to about 50 μm. In other embodiments, the thickness of the clad layers may be from about 8 μm to about 25 μm, such as from about 10 μm to about 20 μm.

In embodiments, the contrasting ion exchange diffusivity exists between two adjacent layers of the laminated glass article, such as the contrasting ion exchange diffusivity between the core layer and adjacent clad layers or contrasting ion exchange diffusivity between two adjacent clad layers. Embodiments include laminated glass articles with a contrasting ion exchange diffusivity between a first layer having an ion exchange diffusivity of D₀ and a second layer having an ion exchange diffusivity of D₁, where D₀/D₁≠1.

In embodiments, D₀/D₁ may be greater than 1, such as from about 1.2 to about 10, or even from about 2 to about 9.5. In other embodiments, D₀/D₁ may be from about 2 to about 9, such as from about 3 to about 8.5. In yet other embodiments, D₀/D₁ may be from about 3.5 to about 8, such as from about 4 to about 7.5. In still other embodiments, D₀/D₁ may be from about 4.5 to about 7, such as from about 5 to about 6.5. In further embodiments, D₀/D₁ may be from about 5.5 to about 6. In other embodiments, D₀/D₁ may be from about 4 to about 10, such as from about 5 to about 10, or even from about 6 to about 10.

In other embodiments, D₀/D₁ may be less than 1, such as from about 0.1 to about 0.9, or even from about 0.2 to about 0.8. In other embodiments, D₀/D₁ may be from about 0.3 to about 0.8, such as from about 0.4 to about 0.7. In yet other embodiments, D₀/D₁ may be from about 0.5 to about 0.6. In other embodiments, D₀/D₁ may be from about 0.15 to about 0.6, such as from about 0.2 to about 0.5, or even from about 0.2 to about 0.4.

In other embodiments, the ion exchange diffusivity of the first layer D₀ or the ion exchange diffusivity of the second layer D₁ is zero.

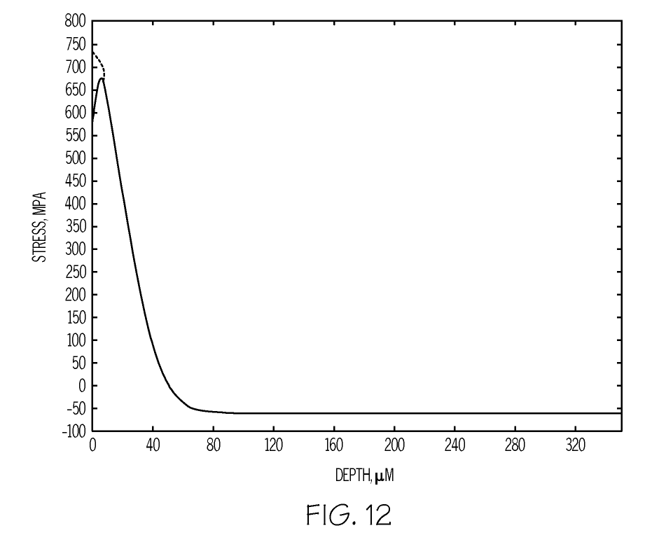

Referring now to FIG. 12, in embodiments, a second ion exchange process can be used to introduce a buried compression peak inside the DOL. Sample 16 is a laminated glass article having a core layer and two clad layers. The laminated glass article of Sample 16 has a total thickness of 0.7 mm, a DOL of 80 μm, and a clad thickness of 8 μm for each clad layer. The clad layer has an ion exchange diffusivity of 120 μm²/hour and the core layer has an ion exchange diffusivity of 24 μm²/hour. The laminated glass article was first ion exchanged by immersion in a molten bath of pure KNO₃ for 770 minutes at a temperature of 390° C. achieving the stress profile shown by the dotted line in FIG. 12. The laminated glass article was then immersed in a second molten bath of poisoned KNO₃, where the molten bath has an effective mole fraction of K⁺ of about 80%, where the effective mole percent K⁺ is calculated by dividing the mole percent of K⁺ by the sum of Na⁺ and K⁺. The stress profile of the laminated glass article having undergone the second ion exchange is shown by the solid line in FIG. 12. The second step ion exchange time was 20 minutes and temperature is about 400° C.

In embodiments, a laminated glass article comprises a first layer comprising a first ion exchange diffusivity, D₀; and a second layer adjacent to the first layer and comprising a second ion exchange diffusivity, D₁, wherein D₀/D₁ is from about 0.1 to about 0.9. Additionally, or alternatively, the first layer is a core layer and the second layer is a clad layer; or the first layer is a first clad layer and the second layer is a second clad layer. Additionally, or alternatively, a central tension of the laminated glass article is less than a threshold central tension (TCT) calculated using formula (2):

TCT(MPa)=−38.7 (MPa/mm)·ln(t)(mm)+48.2 (MPa) (2),

wherein t represents the thickness of the laminated glass article. Additionally, or alternatively, the laminated glass article comprises a compressive stress layer comprising a depth of layer from about 8 μm to about 150 μm or from about 50 μm to about 150 μm. Additionally, or alternatively, the compressive stress layer comprises a maximum compressive stress from about 300 MPa to about 1000 MPa. Additionally, or alternatively, D₀/D₁ is from about 0.2 to about 0.5, the laminated glass article comprises a compressive stress layer comprising a depth of layer that is from about 8 μm to about 80 μm, a maximum compressive stress in the compressive stress layer is from about 500 MPa to about 900 MPa, and a central tension of the laminated glass article is less than a threshold central tension (TCT) calculated using formula (2):

TCT(MPa)=−38.7 (MPa/mm)·ln(t)(mm)+48.2 (MPa) (2),

wherein t represents the thickness of the laminated glass article.

In embodiments, a method for manufacturing a laminated glass article comprises forming a first layer having a first ion exchange diffusivity, D₀; and forming a second layer adjacent to the first layer and having a second ion exchange diffusivity, D₁; wherein D₀/D₁ is from about 0.1 to about 0.9. Additionally, or alternatively, the first layer is a core layer and the second layer is a clad layer; or the first layer is a first clad layer and the second layer is a second clad layer. Additionally, or alternatively, the method further comprises strengthening the laminated glass article by an ion exchange process to form a strengthened laminated glass article having a compressive stress layer with a depth of layer from about 8 μm to about 100 μm. Additionally, or alternatively, the strengthening the laminated glass article comprises immersing the laminated glass article in a substantially pure molten KNO₃ bath for a duration from about 2 hours to about 16 hours at a temperature from about 370° C. to about 530° C. Additionally, or alternatively, the strengthening the laminated glass article comprises immersing the laminated glass article in a second molten KNO₃ bath having an effective mole fraction of K⁺ of less than about 90% for a duration of about 0.2 hours to about 1 hour at a temperature of about 400° C. Additionally, or alternatively, D₀/D₁ is from about 0.2 to about 0.5, the depth of layer is from about 8 μm to about 80 μm, a maximum compressive stress in the compressive stress layer is from about 500 MPa to about 900 MPa, and a central tension of the laminated glass article is less than a threshold central tension (TCT) calculated using formula (2):

TCT(MPa)=−38.7 (MPa/mm)·ln(t)(mm)+48.2 (MPa) (2),

wherein t represents the thickness of the laminated glass article.

The glass articles described herein can be used for a variety of applications including, for example, for cover glass or glass backplane applications in consumer or commercial electronic devices including, for example, LCD, LED, OLED, and quantum dot displays, computer monitors, and automated teller machines (ATMs); for touch screen or touch sensor applications, for portable electronic devices including, for example, mobile telephones, personal media players, and tablet computers; for integrated circuit applications including, for example, semiconductor wafers; for photovoltaic applications; for architectural glass applications; for automotive or vehicular glass applications; for commercial or household appliance applications; for lighting or signage (e.g., static or dynamic signage) applications; or for transportation applications including, for example, rail and aerospace applications.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1. A laminated glass article comprising:
a first layer comprising a first ion exchange diffusivity, D₀; and
a second layer adjacent to the first layer and comprising a second ion exchange diffusivity, D₁,
wherein D₀/D₁ is from about 1.2 to about 10.

2. The laminated glass article of claim 1, wherein the first layer is a core layer and the second layer is a clad layer.

3. The laminated glass article of claim 1, wherein the first layer is a first clad layer and the second layer is a second clad layer.

4. The laminated glass article of claim 1, wherein a central tension of the laminated glass article is less than a threshold central tension (TCT) calculated using formula (2):
TCT(MPa)=−38.7 (MPa/mm)·ln(t)(mm)+48.2 (MPa) (2),
wherein t represents a thickness of the laminated glass article.

5. The laminated glass article of claim 1, wherein the laminated glass article comprises a compressive stress layer with a depth of layer from about 8 μm to about 150 μm.

6. The laminated glass article of claim 5, wherein the depth of layer is from about 50 μm to about 150 μm.

7. The laminated glass article of claim 5, wherein the compressive stress layer has a maximum compressive stress from about 300 MPa to about 1000 MPa.

8. The laminated glass article of claim 1, wherein a thickness of the laminated glass article is from about 0.075 mm to about 4 mm.

9. The laminated glass article of claim 8, wherein the thickness of the laminated glass article is from about 0.3 mm to about 2 mm.

10. The laminated glass article of claim 1, wherein a thickness of the second layer is from about 3 μm to about 100 μm.

11. (canceled)

12. The laminated glass article of claim 1, wherein
D₀/D₁ is from about 5 to about 10,
the laminated glass article comprises a compressive stress layer with a depth of layer that is from about 8 μm to about 80 μm,
a maximum compressive stress in the compressive stress layer is from about 600 MPa to about 900 MPa, and
a central tension of the laminated glass article is less than a threshold central tension (TCT) calculated using formula (2):
TCT(MPa)=−38.7 (MPa/mm)·ln(t)(mm)+48.2 (MPa) (2),
wherein t represents a thickness of the laminated glass article.

13. A method for manufacturing a laminated glass article, the method comprising:
forming a first layer having a first ion exchange diffusivity, D₀; and
forming a second layer adjacent to the first layer and having a second ion exchange diffusivity, D₁;
wherein D₀/D₁ is from about 1.2 to about 10.

14. The method of claim 13, wherein the first layer is a core layer and the second layer is a clad layer.

15. The method of claim 13, wherein the first layer is a first clad layer and the second layer is a second clad layer.

16. The method of claim 13, further comprising strengthening the laminated glass article by an ion exchange process to form a strengthened laminated glass article having a compressive stress layer with a depth of layer from about 8 μm to about 100 μm

17. The method of claim 16, wherein the strengthening the laminated glass article comprises immersing the laminated glass article in a substantially pure molten KNO₃ bath for a duration from about 2 hours to about 16 hours at a temperature from about 370° C. to about 530° C.

18. The method of claim 17, wherein the strengthening the laminated glass article comprises immersing the laminated glass article in a second molten KNO₃ bath having an effective mole fraction of K⁺ of less than about 90% for a duration of about 0.2 hours to about 1 hour at a temperature of about 400° C.

19. The method of claim 13, wherein a thickness of the laminated glass article is from about 0.075 mm to about 4 mm.

20. (canceled)

21. The method of claim 13, wherein a thickness of the second layer is from about 3 μm to about 100 μm.

22. (canceled)

23. The method of claim 13, wherein
D₀/D₁ is from about 5 to about 10,
the depth of layer is from about 8 μm to about 80 μm,
a maximum compressive stress in the compressive stress layer is from about 500 MPa to about 900 MPa, and
a central tension of the laminated glass article is less than a threshold central tension (TCT) calculated using formula (2):
TCT(MPa)=−38.7 (MPa/mm)·ln(t)(mm)+48.2 (MPa) (2),
wherein t represents the thickness of the laminated glass article.
